(19) United States
(12) Patent Application Publication
(10) Pub. No.: US 2006/0055774 A1
(43) Pub. Date: Mar. 16, 2006

(54) Film scanner for color originals

(75) Inventors: Heinz-Wilhelm Hubers, Zeuthen (DE); Andreas Eckardt, Berlin (DE); Hans Driescher, Rudersdorf (DE)

Correspondence Address: COHEN, PONTANI, LIEBERMAN & PAVANE, 551 FIFTH AVENUE, SUITE 1210, NEW YORK, NY, 10176, US

(73) Assignee: Deutsches Zentrum fur Luft-und Raumfahrt e.V.

(21) Appl. No.: 11/224,511

(22) Filed: Sep. 12, 2005

(30) Foreign Application Priority Data
Sep. 15, 2004 (DE) 10 2004 045 559.7

(51) Int. Cl. H04N 5/253

(52) U.S. Cl. 348/97

(57) ABSTRACT

A film scanner for a color original comprises a film stage having a slit-shaped opening, the slit-shaped opening generating an image of the color original when the color original is moving across the film stage while the slit-shaped opening is illuminated by a source of white light; a photosensitive sensor; and a spectrum-splitting element positioned between the film stage and the photosensitive sensor for dividing the image of the color original into its spectral components. The photosensitive sensor is oriented so that desired regions of the spectral components strike the photosensitive sensor. A process for scanning a color original is also disclosed.

### PRIORITY CLAIM

The application claims the priority of German patent application number 10 2004 045 559.7, filed Sep. 15, 2004.

### BACKGROUND OF THE INVENTION

1. Field of the Invention

The invention relates to a film scanner for color originals and a process for scanning color originals.

2. Description of the Related Art

Most film scanners for color originals are based on the principle of producing separate red (“R”), green (“G”), and blue (“B”) images, which are stored and then reassembled into a color image at the time of playback.

There are two different approaches to the production of R, G, and B images. According to the first approach, a separate opening is provided in the film stage for each image. When spectrally selective light sources are used, the light source in question is assigned to its opening, and the corresponding spectrally selective image is recorded. When white-light sources are used, color filters must be either integrated into the film stage or set up in front of photosensitive sensors. Regardless of the choice of light source, the problem occurs that the R, G, and B images of a scene are recorded in chronological succession. Even the smallest variations in the speed of the film drive lead to synchronization difficulties, which result in playback errors.

According to the second approach, the film stage has only a single opening, which is illuminated with white light. A beam splitter then divides this panchromatic light strip into three separate panchromatic light strips. The three partial images are projected through R, G, and B filters onto linear photosensitive sensors. When, as here, only one opening or light slit is used, significant losses of intensity occur when the light slit being scanned is split into at least 3 components. It is not easy to compensate for the loss of intensity by increasing the brightness of the illumination of the slit in the film stage because then the exposed section of film is subjected to too much thermal stress. The scanning rate must therefore be reduced, which is disadvantageous.

### SUMMARY OF THE INVENTION

The invention is directed to a film scanner and scanning method by means of which color originals can be scanned synchronously at high speed.

In accordance with the invention, a spectrum-splitting element is installed between the film stage and at least one photosensitive sensor to divide or separate the projection of the color original into its spectral components. The photosensitive sensor or sensors are positioned or oriented in such a way that the desired regions of the spectral components strike them. As a result, the minimum of three images, i.e., R, G, and B images, can continue to be recorded simultaneously, but the full spectral intensity remains available for each. Work can therefore be carried out at three times the scanning speed of embodiments with beam splitters, without increasing the heat input. The photosensitive sensor or sensors must be oriented or aligned in such a way that the desired parts of the spectrum strike them.

In a preferred embodiment, the spectrum-splitting element is designed as a prism or grating.

In another preferred embodiment, a projection lens is located between the film stage and the spectrum-splitting element and/or between the spectrum-splitting element and the photosensitive sensor.

In yet another preferred embodiment, the photosensitive sensor is designed as a matrix sensor, which can be used to record the entire image spectrum. To form the R, G, and B images, it is necessary merely to select the corresponding columns of the matrix. The particular advantage of this arrangement is that, first, the images can be recorded loss-free, which is very important for archival purposes. In addition, the red, green, and/or blue spectrum in question can be adjusted by combining the individual lines appropriately. This makes it possible, furthermore, to take into account certain spectral properties of the original. For example, the film original may have a different spectral distribution because of aging. The existing current spectral distribution can first be determined by pre-recording part of the film (without image content), and then the corrections can be made by selecting the appropriate lines in the spectrum. Instead of a pre-recorded image without image content, it is also possible to record several images and to average them. In concrete terms, it is possible, for example, to compensate for a greenish tinge in the film by narrowing down the green region of the spectrum.

In yet another preferred embodiment, the photosensitive sensors are designed as linear sensors, and one sensor is assigned to each spectral region, i.e., one to the red region, one to the green region, and one to the blue region. If it is also desired to have the ability to adjust the spectrum in this case, it is necessary merely to set up the sensors so that they can be shifted relative to the spectrum-splitting element. It is also possible to combine a linear sensor arrangement with a matrix and to use the matrix sensor for calibration, for example. For this purpose, this matrix sensor does not have to provide extremely high resolution, because it serves only to determine the spectral distribution of the film material. Then the high-resolution linear sensors are adjusted to the spectral regions.

In yet another preferred embodiment, at least one diaphragm arrangement, preferably adjustable, is set up in front of the photosensitive sensors. A diaphragm arrangement, preferably adjustable, is also preferably set up between the spectrum-splitting element and the projection lens. It is then possible again to adjust the spectrum by adjusting the diaphragm arrangement as appropriate.

Other objects and features of the present invention will become apparent from the following detailed description considered in conjunction with the accompanying drawing. It is to be understood, however, that the drawing is designed solely for purposes of illustration and not as a definition of the limits of the invention, for which reference should be made to the appended claims. It should be further understood that the drawing is not necessarily drawn to scale and that, unless otherwise indicated, it is merely intended to conceptually illustrate the structures and procedures described herein.

### BRIEF DESCRIPTION OF THE DRAWING

In the drawing:

FIG. 1 is a schematic diagram of a film scanner of the present invention.

### DETAILED DESCRIPTION OF THE PRESENTLY PREFERRED EMBODIMENTS

The invention is explained in greater detail below on the basis of a preferred exemplary embodiment.

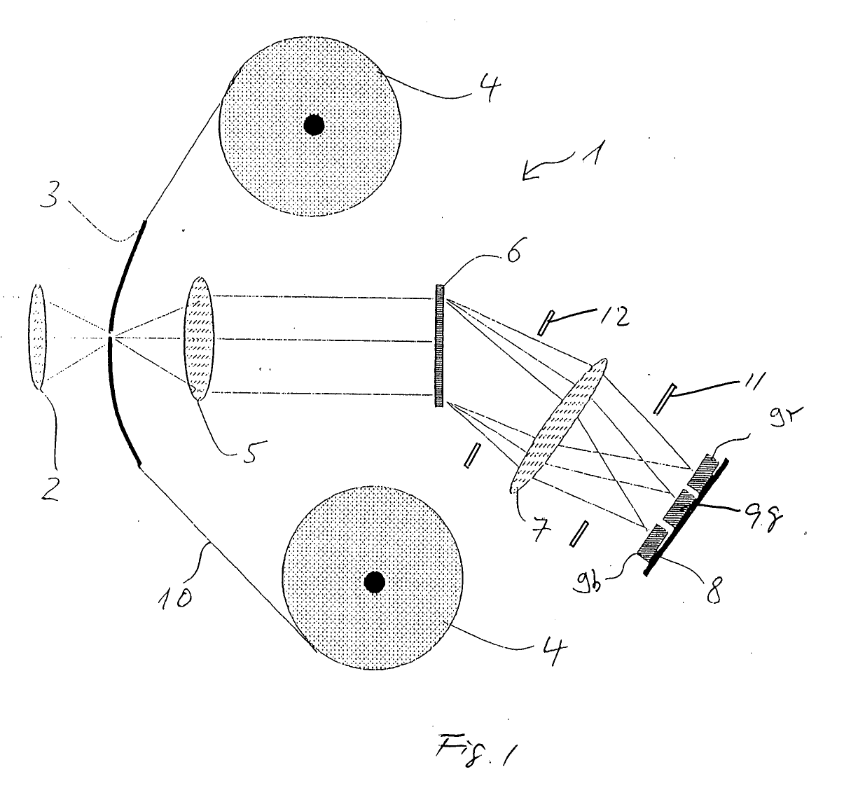

As shown in FIG. 1, the film scanner 1 comprises a source of white light (not shown), a first projection lens 5, a film stage 3, a film drive 4, a second projection lens 7, a spectrum-splitting element 6, a third projection lens 2, and a focal plane 8, on which three linear photosensitive sensors 9 are arranged. These are, for example, panchromatic CCD or CMOS linear sensors. The light emitted by the white light source is parallelized and projected through the third projection lens 2 onto a slit-shaped opening in the film stage 3. The film drive 4 conducts the film 10 to be scanned continuously past the slit-shaped opening. The first projection lens 5 then forms the image of the opening on the spectrum-splitting element 6, which, for example, is designed as a prism. By means of the second projection lens 7, the blue spectral components are projected onto the first sensor 9b, the green spectral components onto the second sensor 9g, and the red spectral components onto the third sensor 9r. By means of the diaphragm arrangements between the spectrum-splitting element 6 and the projection lens 7, the spectral regions which are projected onto the sensors 9 can be limited in a manner specific to the film in question, so that, for example, the spectral regions can be prevented from overlapping each other. At least one diaphragm arrangement 11, preferably adjustable, is set up in front of the photosensitive sensors. A diaphragm arrangement 12, preferably adjustable, is also preferably set up between the spectrum-splitting element and the projection lens. It is then possible again to adjust the spectrum by adjusting the diaphragm arrangement as appropriate.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A film scanner for a color original, comprising:
a film stage having a slit-shaped opening, the slit-shaped opening generating an image of the color original when the color original moves across the film stage while the slit-shaped opening is illuminated by a source of white light;
a photosensitive sensor; and
a spectrum-splitting element positioned between the film stage and the photosensitive sensor and operable to divide the image of the color original into its spectral components,
wherein the photosensitive sensor is oriented so that desired regions of the spectral components strike the photosensitive sensor.

2. The film scanner of claim 1, wherein the spectrum-splitting element is a prism or grating.

3. The film scanner of claim 1, further comprising a projection lens positioned between the film stage and the spectrum-splitting element.

4. The film scanner of claim 2, further comprising a projection lens positioned between the film stage and the spectrum-splitting element.

5. The film scanner of claim 1, further comprising a projection lens positioned between the spectrum-splitting element and the photosensitive sensor.

6. The film scanner of claim 2, further comprising a projection lens positioned between the spectrum-splitting element and the photosensitive sensor.

7. The film scanner of claim 1, wherein the photosensitive sensor is a matrix sensor.

8. The film scanner of claim 1, wherein the photosensitive senor comprises three sub-sensors, a first sub-senor operable to sense red spectral components, a second sub-senor operable to sense green spectral components, and a third sub-senor operable to sense blue spectral components.

9. The film scanner of claim 8, wherein the sub-sensors are linear sensors.

10. The film scanner of claim 5, further comprising a diaphragm positioned between the projection lens and the photosensitive sensor.

11. The film scanner of claim 10, wherein the diaphragm is adjustable.

12. The film scanner of claim 5, further comprising a diaphragm positioned between the spectrum slitting element and the projection lens.

13. The film scanner of claim 12, wherein the diaphragm is adjustable.

14. The film scanner of claim 1, wherein the desired regions of the spectral components striking the photosensitive sensor can be adjusted as a function of the spectral properties of the color original.

15. A process for scanning a color original by the film scanner of claim 1, wherein the desired regions of the spectral components which strike the photosensitive sensor or which are read out from the photosensitive sensor are adjusted as a function of the spectral properties of the color original.

16. The film scanner of claim 1, further comprising a first projection lens positioned between the film stage and the spectrum-splitting element, and a second projection lens positioned between the spectrum-splitting element and the photosensitive sensor.

17. The film scanner of claim 16, further comprising a third projection lens positioned between the source of white light and the film stage.
